(19) United States
(12) Patent Application Publication
(10) Pub. No.: US 2015/0008011 A1
(43) Pub. Date: Jan. 8, 2015

(54) SIGNAL CABLE FOR HIGH FREQUENCY SIGNAL TRANSMISSION AND METHOD OF TRANSMISSION

(71) Applicant: LEONI KABEL HOLDING GMBH, NUERNBERG (DE)

(72) Inventors: ERWIN KOEPPENDOERFER, SCHWABACH (DE); WOLFGANG STEUFF, WEISSENBURG (DE); MATTHIAS WICKENHOEFER, GRAFENWIESEN (DE); BERND JANSSEN, FRIESOYTHE OT NEUSCHARREL (DE)

(21) Appl. No.: 14/492,263

(22) Filed: Sep. 22, 2014

Related U.S. Application Data
(63) Continuation of application No. PCT/EP2013/000770, filed on Mar. 14, 2013.

(30) Foreign Application Priority Data
Mar. 21, 2012 (DE) 102012204554.6

(51) Int. Cl. H01B 11/02; H01B 7/00; H01B 11/18

(52) U.S. Cl. CPC H01B 11/02; H01B 11/1808; H01B 7/0009
USPC 174/113 R

(57) ABSTRACT

A signal cable, namely a coaxial cable or a balanced cable, has at least one signal conductor for transmitting high frequency signals, in particular also in the gigahertz range, while having an acceptable return loss. It is provided optionally or in combination that the signal conductor is embodied as a stranded conductor with a varying lay length or that the signal cable is a balanced cable having signal conductors that are mutually twisted with a varying lay length.

### CROSS-REFERENCE TO RELATED APPLICATION

This is a continuation application, under 35 U.S.C. §120, of copending international application No. PCT/EP2013/000770, filed Mar. 14, 2013, which designated the United States; this application also claims the priority, under 35 U.S.C. §119, of German patent application No. 10 2012 204 554.6, filed Mar. 21, 2012; the prior applications are herewith incorporated by reference in their entireties.

### BACKGROUND OF THE INVENTION

### Field of the Invention

The invention relates to a signal cable, namely a coaxial cable or a balanced signal cable. The invention further relates to the use of a signal cable of this type for transmitting high frequency signals.

Coaxial cables are frequently used as signal cables for transmitting high frequency signals, by way of example in the GHz range. The special construction of the coaxial cables having a central inner conductor that is embodied as the signal conductor together with the dielectric medium and also a hollow cylindrical outer conductor that is embodied by one or multiple shielding layers renders it possible to transmit also high frequency broadband signals in an interference-free manner. The shielding layer acts as a shield against any external interference fields and the external interference fields do not have any influence on the signal transmission in the case of the inner conductor.

In addition to coaxial cables, so-called balanced signal cables are also used for signal transmission. The balanced signal cables contain at least a pair of insulated signal conductors that are mutually twisted and form a twisted element. This twisted element is encompassed by a shielding (pair shielding). The two signal conductors of the pair are controlled in a balanced manner by the signal to be transmitted, wherein the original signal is fed into one signal conductor and an inverted (phase-shifted by 180°) signal is fed into the other signal conductor. The level difference between the two signal conductors is evaluated. In the case of an external interference level, this has an identical effect on the two signal levels in the signal conductors so that the difference signal remains unaffected.

In the case of transmitting signals in particular in computer networks, use is made of cables through which are guided multiple wire pairs that are adjacent one to the other in a common cable sheath, the wire pairs being mutually twisted in pairs and unshielded. Typical data cables of this type are by way of example four or also more wire pairs that are guided together. Cables of this type are by way of example used in computer networks as Cat 5 or Cat 6 cables. In the case of computer cables of this type or also telephone cables, the so-called cross-talk is known to have an interfering effect, wherein the signal transmission in one wire pair influences the signal transmission in the other wire pair.

Different measures are known in order to avoid or at least reduce this cross-talk. For example, U.S. Pat. Nos. 7,109,424 B2 and 6,959,533 B2 by way of example disclose a variation of the lay length of the wire pairs. A further approach that is described by way of example in international patent disclosure WO 2005/041 219 A1 proposes that the Cat 5 or Cat 6 cabling is achieved by twisting individual wire pairs with different lay lengths.

U.S. Pat. No. 6,318,062 B1 discloses by way of example a twisting machine with which it is possible to vary the lay length of a wire pair.

A further approach for avoiding or attenuating the cross-talk behavior provides an individual shielding for a respective wire pair so that as a result the adjacent pair does not have any interfering influence.

German patent DE 19 43 229 describes a further aspect that is not related to the problem of cross-talk, namely the so-called return loss. This occurs by way of example in the case of coaxial lines as a result of the impedance changes in the transmission route, as a consequence of which the signal is reflected at an impedance discontinuity caused by the impedance change so that overall a signal is attenuated (return loss).

German patent DE 19 43 229 discloses that a periodic deformation of a cable having a multiplicity of mutually twisted coaxial conductors leads to a high magnitude of return loss in the case of defined transmission frequencies. In accordance with DE 19 43 229 deformations of this type in the coaxial conductors are caused as a result of mechanical loading on the respective coaxial conductor during the twisting process.

In accordance with this document, it is provided in order to avoid return loss to change the periodicity of the mechanical deformations by modifying the twisting process, the periodicity being caused by the twisting process. The impedance discontinuity that is caused by the deformation therefore no longer occurs at periodically repeating sites so that the signal portions that are reflected at the individual impedance discontinuities are not summated.

### SUMMARY OF THE INVENTION

It follows from this that the object of the invention is to provide a signal cable, namely a coaxial cable or a balanced cable, having improved characteristics in particular when transmitting high frequency data signals.

The signal cable is configured and provided as a high frequency signal cable for transmitting signals at a frequency in the gigahertz range in particular up to approximately 100 gigahertz. The signal cable is embodied as desired as a coaxial cable or as a balanced signal cable. The coaxial cable generally contains a signal conductor that is embodied as an inner conductor and is encompassed by a dielectric medium and subsequently is encompassed by a conventional outer conductor that is embodied as a braid shield and is in turn encompassed by a cable sheath. The balanced signal cable contains at least one pair of wires that are mutually twisted, the wire pair being embodied from two insulated signal conductors and being encompassed by a shielding. In accordance with a first design variant, the shielding encompasses precisely one wire pair, each wire pair of the cable being therefore directly encompassed by a pair shielding. In addition to these individual wire pairs that are provided with a pair shielding, the so-called quad twisted arrangement is also known in the case of a balanced signal cable, wherein two wire pairs that form one signal pair are mutually twisted together. This quad twisted element is likewise directly encompassed by a shielding. In the case of a star quad of this type, the four individual signal conductors are arranged in a square format, wherein the diagonally opposite-lying signal conductors form in each case a signal pair for transmitting a respective signal data.

In the case of signal cables of this type, the present invention provides that henceforth the signal conductor is embodied as a stranded conductor containing a number of individual stranded wires and the stranded wires are mutually twisted with a varying lay length. As an alternative thereto or in combination thereof, the signal conductors in the case of a balanced signal cable are mutually twisted with a varying lay length.

This embodiment is based on the knowledge that even the signal cables that are greatly homogenous, as used nowadays already for transmitting signals by way of example up to 100 megahertz, are suitable only in certain conditions for higher frequency signals by way of example greater than 500 megahertz and in particular in the one digit gigahertz range. Tests have shown that despite a precise homogenous embodiment of the coaxial cable without defects resulting from deformation, as they are described by way of example in German patent DE 19 43 229, a return loss occurs at defined frequencies. It has been further recognized that these interferences are caused as a result of the fundamental twisting periodicity of the twisted components, in other words either the mutually twisted individual stranded wires of the signal conductor that is embodied as a stranded conductor or by virtue of the mutually twisted signal conductors in the case of a balanced cable. Based on this knowledge, the varying lay length is selected, as a consequence of which the return loss that occurs in the case of a defined frequency range is reduced or rather is distributed over a greater frequency band.

This embodiment with the varying lay length is therefore based on the knowledge that periodic structures are introduced directly as a result of the twisting or braiding process and the structures, despite the homogenous, interference-free embodiment of the signal cable without defects resulting from deformation, surprisingly represent a periodically re-occurring, regular interference for high frequency data transmission. This interference leads to an increase of the return loss, i.e. at least one frequency-fixed signal portion is repeatedly reflected and returned and consequently reduces the transmitted signal output. The term ‘return loss’ is generally understood to mean the ratio between the transmitted output that is to be reflected or rather the stored energy and the back-scattered energy. The return loss is therefore a measurement for back-scattering effects in the case of signal propagation in the signal cable. The back-scattering effects occur at interference sites in the transmission route.

As a result of the periodic interference that is introduced by a fixed lay length, this has a selective effect on defined wave lengths. In particular, signal portions of the type whose wave lengths lie in the range of half lay lengths or are a whole number of times the half lay length are affected. The return loss therefore demonstrates interference peaks if n*λ/2=s, wherein n represents a whole number, λ represents the wave length of the data signal and s represents the lay length. In the case of double twisting machines, the periodic spacing that causes the interference is the double lay length so that in the case of cables or rather conductors that are produced using a double twisting machine the interference peaks occur if n*λ/2=2s. This problem of the interference peaks in the return loss occurs in particular in the case of high frequency signals in the upper megahertz and in the gigahertz range since in this case the typical lay lengths of stranded conductors lie in the range of a multiple of λ/2 or rather λ/4. In the case of a single lay twisting machine and a lay length s of 10 mm, the interference peaks occur at 10 GHz(λ/2=s), 20 GHz (2*λ/2=s), 30 GHz (3*λ/2=s) etc. In the case of a double lay twisting machine, the interference peaks occur at 5 GHz(λ/2=2s), 10 GHz (2*λ/2=2s), 15 GHz (3*λ/2=2s) etc.

The periodic structure that is introduced by the lay length therefore leads selectively to a high, peak-like return loss within the signal in the case of a defined frequency (wave length). By virtue of the varying lay length, this peak is reduced in the case of a defined frequency so that overall in the case of this critical frequency the return loss is reduced. By virtue of varying the lay length, the return loss is distributed overall on a wider frequency band as a consequence of the interference that is introduced by the twisting process. The option is consequently available overall for the individual frequencies to maintain the maximum permissible return loss even in the case of high frequency data signals.

The term lay length of a stranded conductor' is generally understood to mean the length that an individual stranded wire requires as a result of the twisting process in order to perform a complete winding (360 degrees) in the longitudinal direction around a stranded wire center. The term ‘varying lay length’ is therefore understood to mean that the length spacing that a respective individual stranded wire requires for a 360 degree rotation changes over the length of the stranded conductor. Accordingly, the term lay length of the twisted element' is understood also to mean the length that the individual insulated signal conductor requires for a complete winding.

The term ‘stranded conductors’ is understood to mean presently preferred so-called concentric stranded conductors, wherein the individual stranded wires comprise a precisely defined layer so that a regular construction is guaranteed. The individual stranded wires are generally one or multiple layers of individual stranded wires that are twisted about a stranded wire center. The stranded wire center itself is generally also a stranded wire. In the case of a single layer stranded conductor, the central stranded wire is encompassed by six further stranded wires. In the case of a double layer stranded conductor, these are in turn encompassed by 12 individual wires in the second layer, in the case of a three layer stranded conductor, these are in turn encompassed by 18 individual wires in the third layer. In addition, the stranded conductors can also be embodied alternatively as so-called bundled conductors. In the case of the bundled conductors, multiple individual wires or wire bundles are braided. In contrast to concentric braids, the individual wires do not assume a precisely defined layer within the braid and there is no fixed arrangement for arranging the individual wires with respect to one another.

The term ‘balanced signal cable’ is understood to mean cables having at least one conductor pair containing insulated signal conductors that are provided jointly for transmitting a signal by feeding in one original signal and one signal that is inverted with respect thereto. In the case of a so-called twisted pair, the conductor pair forms the twisted element that is encompassed by the shielding. In addition to the twisted pair, there is also a so-called quad twisted element, known in particular as the star quad, wherein in each case two conductors (insulated signal conductors), in the case of the star quad, the diagonally opposite lying signal conductors, form the respective conductor pair. The four signal conductors that are mutually twisted in the case of the quad twisted element form the twisted element that is encompassed by the shielding. The signal cable contains in a preferred variant multiple twisted elements that are encompassed by a shielding, in other words by way of example multiple shielded pairs or star quads or combinations thereof that are normally encompassed by a further complete shielding.

In accordance with one preferred embodiment, the lay length varies with a predefined difference value about a mean lay length. The lay length therefore varies upwards or downwards about a mean value within a band width that is formed by the difference value. The mean lay length plus the difference value therefore provides a maximal lay length and the mean lay length minus the difference value provides the minimal lay length. Intermediate values are assumed between the maximal and the minimal lay lengths.

It is preferred that the difference value is in the range of 5 to 25 percent and in particular in the range of 10 to 20 percent of the mean lay length. The lay length formed in this manner therefore varies between 80 and 90 percent of the mean lay length as a minimal lay length up to 110 to 120 percent of the mean lay length as a maximal lay length.

In one expedient embodiment, the lay length oscillates about the mean lay length, in other words continuously increases to a maximal lay length and decreases to a minimal lay length in an alternating manner. The change in the lay length is preferably continuous and constant. The increase and decrease occurs in particular as a result of a by way of example sine-shaped wave movement.

The variation of the lay length can be achieved in a particularly simple manner as far as production technology is concerned. In the case of braiding or twisting machines that are electronically controlled, this variation is achieved by way of example by varying the rotational speed of the so-called lay bracket during the twisting process and/or by varying the haul-off speed in the longitudinal direction. In the case of mechanically-coupled twisting or braiding machines, it is possible to achieve a varying lay length by way of eccentrically mounted wheels within a drive transmission.

As an alternative to a uniformly by way of example sine-shaped change in the lay length, a non-uniform variation is provided in a preferred embodiment. The lay length changes therefore in particular automatically, preferably in a random manner. This is achieved in particular in the case of electronically controlled twisting machines preferably by correspondingly controlling the twisting machine in a non-uniform manner. The lay length is predefined in particular by way of example by way of a random generator.

For typical applications, the mean lay length is preferably in the range of 1 to 40 mm, in particular in the range of 5 to 40 mm. In an expedient manner, the mean lay length is generally approximately 3 to 50 times the diameter of the signal conductor. By virtue of this selected band width of the mean lay length in combination with the selected mean lay lengths, a stranded conductor that has good return loss characteristics even in the case of high frequencies is achieved on the basis of the current conventional stranded conductors with conventional lay lengths.

The varying lay length can be characterized by an envelope that indicates in other words the increase and accordingly the decrease in the lay length. In accordance with one expedient embodiment, the envelope itself has a length in the range of a few meters. The envelope can have a length of a maximum up to 50 meters but preferably has a length that is considerably less, by way of example is only 0.3 meters. It is therefore fundamentally possible that, according to this length or periodicity of the envelope, a respective lay length repeats itself, in other words repeats with a periodicity that corresponds to the periodicity of the envelope. By virtue of the selected length of the envelope in the region of a few meters, it is achieved that in the case of typical cable lengths, for which the signal cables are conventionally used, at the most only a few lay lengths repeat in an identical manner. Overall, this arrangement effectively avoids a high return loss peak. Signal cables of this type are by way of example used as so-called patch cables in networks. Generally, the cable lengths lie in the range of a few meters, maximum by way of example at 30 m and in particular at a maximum approximately 15 m.

In order to reduce the effect of a periodicity of the envelope, it is provided in one expedient embodiment to vary the length of the envelope. The length of the envelope is characterized by the spacing of two zero crossings through the mean lay length as the lay length increases. The length of the envelope in the case of a wave-shaped envelope therefore corresponds to the length of the complete wave, by way of example a sine-shaped wave. The envelope is preferably in each case a balanced wave, by way of example a sine-shaped or zigzag-shaped wave. This is therefore preferably merely extended. Its maximal and minimal values remain the same. By virtue of varying the length, it is achieved in an advantageous manner that the spacing between two identical lay lengths varies from envelope to envelope, in other words identical lay lengths do not comprise a fixed periodicity with respect to one another.

In an expedient manner, the variation of the length of the envelope is comparatively small and is by way of example only 5 to 10 percent of a mean length of the envelope. A varying adjustment of this type both of the lay lengths and also of the envelope of the lay lengths can be achieved in a particularly simple manner as far as production technology is concerned using electronically controlled twisting machines by a corresponding control in particular of the haul-off speed. Overall, a twisted element of this type can therefore be produced in a comparatively simple manner as far as process technology is concerned.

The variation of the envelope can be fundamentally described in turn by a complete envelope. This is preferably likewise defined by way of example by means of a wave. The length of the envelope therefore varies within the length of the complete envelope in each case continuously about a mean value. The length of the complete envelope is preferably in the range of multiple 10 meters and in particular in the range of by way of example 20 to 30 meters. It is ensured by this measure that, within the conventional cable lengths for which the present signal cables are used, a repeat of the lay length with an identical periodicity is excluded.

In general, a uniform variation of the lay length is achieved by varying the envelope and also by the complete envelope and the variation can be managed in a simple manner as far as process technology is concerned. In addition, it is also fundamentally possible to vary the individual parameters of the lay length in a rather random and chaotic manner. It is preferred that the envelope formed in this manner and in particular the complete casing does not have a periodicity.

For example, the maximal and accordingly minimal lay length varies by way of example in accordance with an expedient embodiment within two successive envelopes, in other words, the maxima and accordingly the minima of the envelopes assume different values.

Furthermore, it is provided in one expedient further development that the gradient of successive envelopes varies. It can also be provided that the rate of increase is different from the rate of the decrease within one envelope. The increase and accordingly the decrease of the lay length therefore vary between two maxima and accordingly minima.

A still further improved return loss is achieved by varying the lay length overall in an overall non-uniform, random or also chaotic manner in comparison to a uniformly varied lay length since in so doing no periodic structures are contained within the twisted element.

Overall, as a consequence, with a comparatively small production outlay, a signal cable is provided that is considerably improved with respect to the return loss.

This described twisting concept with the varying lay length for avoiding or at least reducing the return loss is used in accordance with a first design variant in the case of coaxial conductors that contain a stranded conductor as a signal conductor. It is preferred that a single layer stranded conductor is used as a stranded conductor, wherein in other words only one lay of stranded wires is used that are twisted by way of example about a central stranded wire. The stranded conductor is twisted during a single stage twisting process as this is particularly cost effective.

If a multi-layer stranded conductor is used, wherein in other words multiple layers of individual stranded wires are arranged in a concentric manner with respect to one another, the individual layers then contain for example in each case the same lay direction and lay length. Even in this case, the stranded conductor is therefore produced in an expedient manner in a single stage twisting process for reasons of cost. The individual stranded wires therefore extend generally in parallel with one another and contain therefore in each case the identical lay length with respect to one another.

The use of a stranded conductor of this type is fundamentally not limited to the use in coaxial cables, but rather is preferably also used in the case of other high frequency signal cables that have stranded conductors, in particular in the case of balanced signal cables.

This described twisting concept with the varying lay length is used in accordance with the second design variant when twisting balanced signal cables. Balanced signal cables of this type contain in each case a signal pair or a star quad that is encompassed by a shielding. The shielding in itself is a reliable protection against interfering influences from outside, such as by way of example the cross-talk behavior. Wire pairs of this type that are encompassed by a pair shielding are used by way of example in the case of network cables in accordance with Cat 7, Cat 7a and higher values. However, it has been demonstrated that the problem of return loss occurs even in the case of these twisted signal conductors that are encompassed by a shielding. In order to at least reduce this problem, the signal conductors with a varying length are accordingly also twisted, as described above. In the case of these signal cables, different interfering influences are therefore avoided, namely interfering influences from outside or cross-talk problems on the one hand and the return loss problem on the other hand, by two different measures, namely on the one hand the shielding and on the other hand the varying lay length.

In a particularly preferred embodiment, the individual signal conductors of the twisted element (wire pair and accordingly star quad) contain stranded conductors and both the signal conductors and also the individual stranded wires are embodied with varying lay lengths. In order to reduce the return loss, a double twisted optimization is therefore provided.

In the case of a balanced signal cable, the cable is connected in the assembled state in each case to a feeder device and to an evaluating device, wherein by way of the feeder device an original signal that is to be transmitted is fed into one signal conductor and a signal that is inverted with respect to the original signal is fed into the other signal conductor. The evaluating device is embodied for the purpose of evaluating the level difference between these two signals. This also further eliminates interfering influences from outside since these typically simultaneously affect both signal portions and consequently the level difference remains unaffected.

The shielding is conventionally embodied as a shield braid both in the case of a coaxial cable and also in the case of a balanced signal cable. In the case of a coaxial cable, this simultaneously forms the outer conductor. The braid is generally a hollow body that extends in the longitudinal direction and is formed by the regular mutual twisting of a plurality of braided strands. The braided strands themselves comprise in turn a multiplicity of individual fine single wires. Conventionally, the individual braided strands are likewise mutually twisted with a fixed lay length. The braid or rather the shielding is generally embodied in such a manner that a particularly uniform shielding is provided outwards and inwards. Accordingly, the shielding is embodied in a homogenous manner and contains a constant shielding attenuation. With a view to achieving an efficient shielding arrangement, it is preferred that double-shielded shieldings are provided that are typically formed from two shielding layers, wherein one layer is formed by way of example from the shield braid and the other layer is formed from a metal film.

In an expedient manner, a preferred further development provides that the lay lengths of the individual braided strands of a shield braid of this type henceforth also vary over the length of the shield braid. As in the case of the varying lay length of the individual wires of the stranded conductor, a non-uniform variation is preferably also provided in this case. In addition, a uniform variation is also possible. Fundamentally, the embodiment of the shield braid with the varying lay length is also possible and is provided independently of the embodiment of the stranded conductor and/or of the twisted element with a varying lay length. The right to file a divisional application relating to this aspect is reserved.

Overall, the signal cable in the expedient embodiment is therefore embodied as a high frequency cable for transmitting data at a frequency in the gigahertz range, in particular up to approximately 100 gigahertz.

Other features which are considered as characteristic for the invention are set forth in the appended claims.

Although the invention is illustrated and described herein as embodied in a signal cable for high frequency signal transmission, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, sectional view through a coaxial cable;

FIG. 2 is a side view of a stranded conductor;

FIG. 3 is a diagrammatic, sectional view through a balanced signal cable having a twisted-pair conductor pair;

FIG. 4 is a greatly simplified illustration of a device for data transmission having a balanced signal cable;

FIG. 5 is a side view of a braided shield of the coaxial cable;

FIG. 6 is a graph illustrating a uniformly varying progression of the lay length;

FIG. 7 is a graph illustrating a varying envelope of the lay length;

FIG. 8 is a graph illustrating a greatly non-uniformly varying progression of the lay length;

FIG. 9A is a graph illustrating a qualitative illustration of a progression of a return loss with respect to a frequency of a signal in the case of a stranded conductor with a constant lay length; and

FIG. 9B is a graph illustrating the qualitative progression of the return loss with respect to the frequency of a signal in the case of a stranded conductor that has a variable lay length.

### DETAILED DESCRIPTION OF THE INVENTION

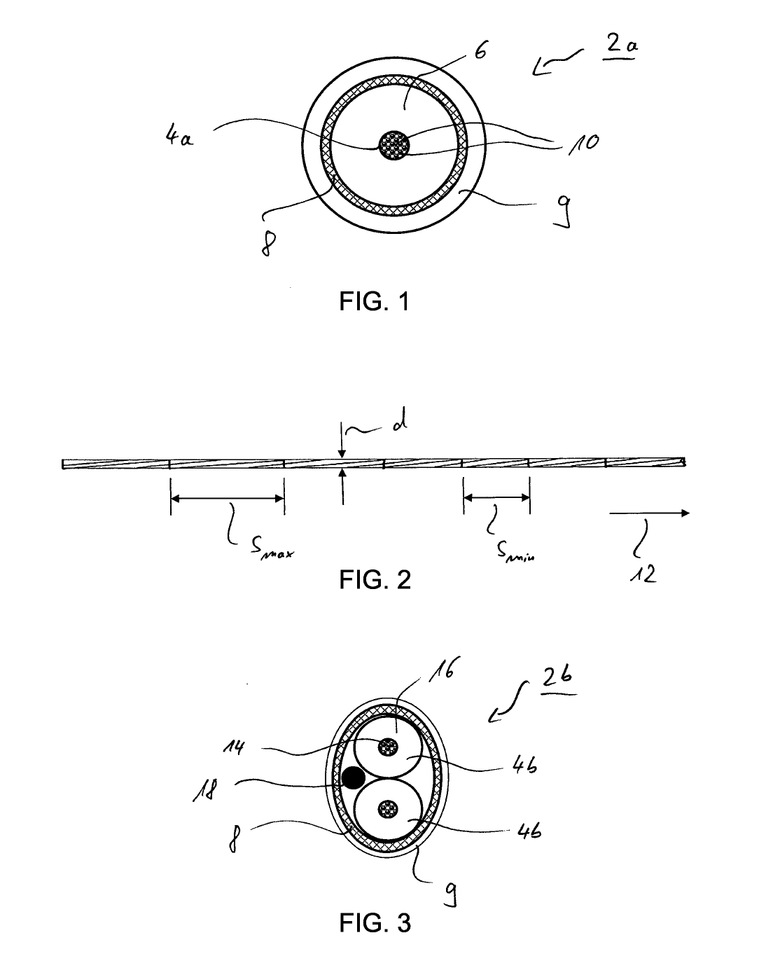

In all the figures of the drawing, sub-features and integral parts that correspond to one another bear the same reference symbol in each case. Referring now to the figures of the drawings in detail and first, particularly to FIG. 1 thereof, there is shown a coaxial cable 2a which contains a central inner/signal conductor that is embodied as a stranded conductor 4A and that is encompassed in a concentric manner by a dielectric medium 6 and subsequently by an outer conductor that is formed by a shielding 8 that is formed by a shield braid. The shielding 8 is in turn encompassed by a cable sheath 9. The stranded conductor 4a contains a multiplicity of individual mutually twisted stranded wires 10.

The individual stranded wires 10 are mutually twisted in such a manner that they extend in each case along a helical line in a longitudinal direction 12 of the stranded conductor 4a. In general, a lay length s is defined by the length in the longitudinal direction 12 that a stranded wire 10 requires for a complete 360 degree rotation.

FIG. 2 illustrates schematically different lay lengths s of the stranded conductor 4a. The illustration highlights a maximal lay length sₘₐₓ and a minimal lay length sₘᵢₙ. As is evident with reference to the lateral view of FIG. 2, the lay length s changes over the length of the stranded conductor 4a.

The balanced signal cable 2b in accordance with FIG. 3 comprises in the exemplary embodiment a conductor pair containing two insulated signal conductors 4b. The signal conductors 4b are formed from a conductor core 14 and an insulation 16 that encompasses the conductor core 14. The conductor core 14 is preferably a full conductor that is embodied as a wire, or is alternatively a stranded conductor optionally with a constant or variable lay length. The conductor pair is encompassed by a shielding 8 and this in turn is encompassed by a cable sheath 9. The conductor pair forms a twisted element. In the exemplary embodiment, a so-called parallel cable 18 is provided in addition but it is not absolutely necessary. The signal cable 2b in the exemplary embodiment contains the twisted element that is shielded and encompassed by the cable sheath 9. In alternative embodiments, multiple units of this type are combined to form one complete cable unit and are encompassed in particular by a complete cable unit shielding and a complete cable sheath.

In a similar manner to the individual stranded wires 10 in the case of the stranded conductor 4a, the signal conductors 4b of the twisted element are for example mutually twisted with a varying lay length s. The situation illustrated in FIG. 2 therefore applies to the same extent for the twisted element.

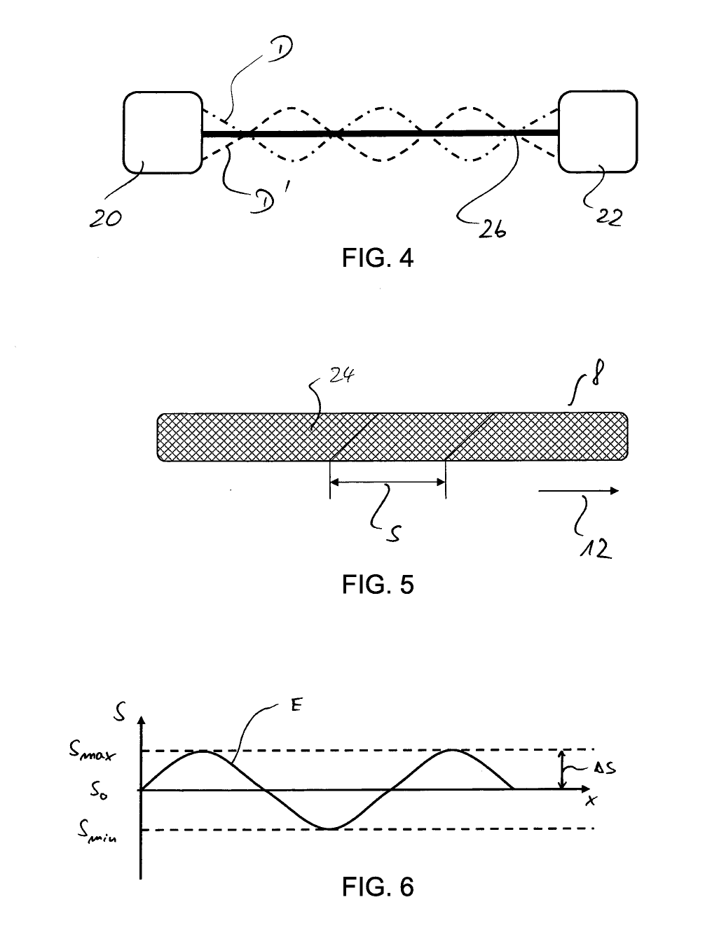

In accordance with FIG. 4, in the case of signal transmission by way of a balanced cable, a signal to be transmitted is fed with the aid of a feeder device 20 into the signal cable 2b and decoupled and evaluated with the aid of an evaluation device 22. As is indicated schematically by the broken lines, an original signal D is fed into one signal conductor 4b and an inverted signal D′ that is phase shifted by 180° is fed into the other signal conductor. The evaluating device evaluates the level difference between the signal levels of these signals D, D′.

FIG. 5 illustrates schematically a lateral view of the shielding 8 that is formed by a shield braid. The shielding 8 contains a multiplicity of mutually twisted braided strands 24. The braided strands are likewise in turn mutually twisted with a lay length s, as is illustrated schematically in FIG. 2. The term lay length s′ is also to be understood in this figure to mean the length that a respective braided strand 24 requires in order to perform a complete rotation) (360°).

FIGS. 6 to 8 illustrate different progressions of the varying lay length s. These figures apply to the same extent for the twisting of the stranded conductor 4a of the twisted element and also for the shield braid. FIG. 6 illustrates in the first instance a uniform variation of the lay length s. This illustrates on the X-axis the lay length s that is plotted with respect to extension in the x-direction and consequently in the direction of the longitudinal direction 12. As is evident, the lay length s oscillates about a mean lay length s₀ and in fact in each case by a difference value Δs. In fact, starting from the maximal lay length sₘₐₓ, the lay length s continuously reduces until it achieves the minimal lay length sₘᵢₙ in order finally to return back to the maximal lay length sₘₐₓ. The lay length s therefore oscillates about the mean lay length s₀ in particular uniformly and in a wave-shaped manner as is illustrated by way of example in FIG. 4. It is preferred that the frequency of this oscillating variation is not a multiple of the number of twisted rotations. The term ‘number of twisted rotations’ is understood to mean in particular the number of rotations per unit of time of the wire or conductor to be twisted during the twisting process.

The varying lay length s is characterized by an envelope (waveform) E that is illustrated in the exemplary embodiment in the form of a sine curve. As an alternative thereto, the envelope (waveform) E preferably increases and accordingly decreases in a straight line and is therefore embodied in an almost zigzag manner. By virtue of the uniform variation of the lay length s as illustrated in FIG. 6, the envelope contains a fixed periodicity.

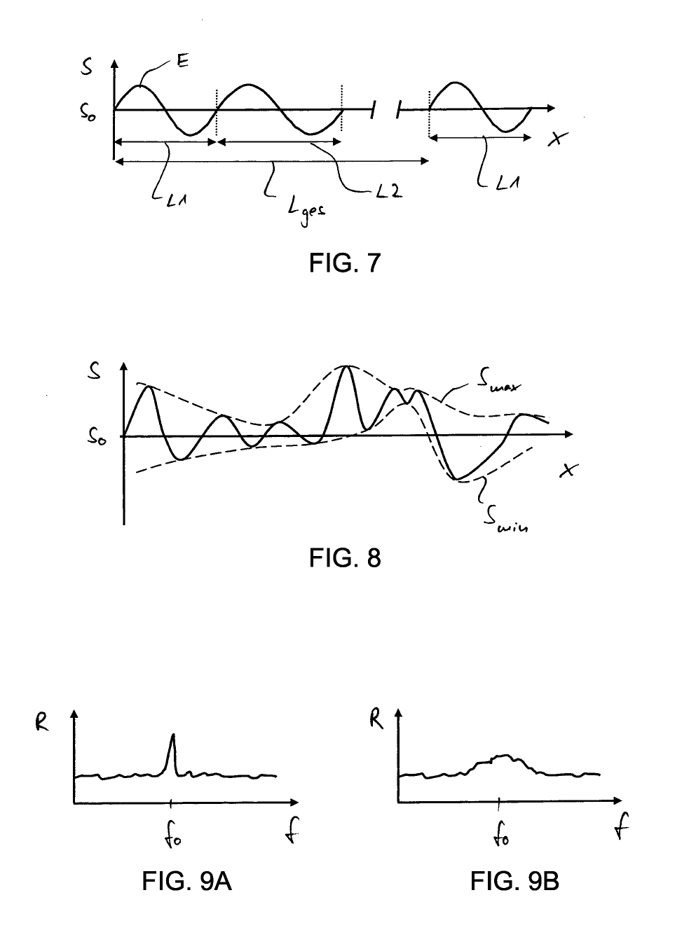

However, one design variant is preferably provided, wherein the envelope E itself varies so that identical lay lengths are arranged within different envelopes E with respect to one another not with the same periodicity. This is described in detail with reference to FIG. 7. As is evident from FIG. 7, the length L of the envelope E varies preferably in a continuous manner. By way of example, two envelopes are illustrated with two different lengths L₁, L₂. The variation of the envelope itself likewise contains again one period so that after an overall length L_{ges} the first envelope re-commences with the length L₁.

The variation of the individual lengths L, L₂ of the envelope E can in turn be represented by a complete envelope that is not illustrated in detail in the figure. The total length of the complete envelope corresponds to the illustrated total length L_{ges}. The total length L_{ges} is preferably in the range of 0.3 to 50 meters, whereas the length L of the envelope E is typically in the range of a few meters by way of example approximately 3 meters. The variation of the envelope E is in the range of preferably 5 to 10 percent of the length L of the envelope.

This variation illustrated in FIG. 7 of the lay length s with the variation of the length of the envelope E is overall, by virtue of the uniform successive variation of the lay length, simple to implement as far as the process technology is concerned and is therefore preferred.

As an alternative to this uniform variation, in alternative embodiments, a non-uniform variation of the lay length s is provided, as is illustrated by way of example in FIG. 8. It is evident from FIG. 8 that the lay length s varies preferably in a random manner or also in a chaotic manner. On the one hand, the rate of increase and accordingly decrease of the lay length s changes over the length x of the signal conductor 2 in the longitudinal direction 12. In the illustration in accordance with FIG. 8, this corresponds to the gradient of the curve representing the lay length s. In other words, the increase and accordingly decrease in the lay length s varies per defined unit of length of the signal conductor 2 and in fact in particular with regard in each case to a pre-defined absolute value of the lay length s. Therefore, the increasing and accordingly decreasing ranges between the two turning points are always compared.

In addition to the variation of the rate of the increase or decrease, the intensity, in other words the respective assumed maximal values sₘₐₓ and also minimal values sₘᵢₙ, of the illustrated progression of the lay length s also varies. In contrast to the uniform variation as illustrated in FIG. 6, the envelope, illustrated by the broken line, of the maximal values is therefore not a straight line but rather a curve progression that in particular does not follow a pre-defined function.

The stranded conductor 4a contains a diameter d. The mean lay length s₀ is typically approximately in the range of 3 to 50 times the strand diameter d. In the case of typical strand diameters d, the lay length is therefore in the range of approximately 1 mm to 40 mm. The same numbers apply preferably also for the twisted element in the case of the balanced signal cable 2b. The mean lay length s₀ is therefore likewise preferably approximately in the range of 3 to 50 times the diameter of the respective signal conductor 4b.

In the case of a lay length s that varies in this manner, the so-called return loss R can be improved. This is illustrated with reference to FIGS. 9A, 9B. FIG. 9A illustrates the situation by way of example in the case of a stranded conductor 4a (or rather twisted element) that has a constant uniform lay length s. As is evident, the progression of the return loss in the case of a frequency f₀ illustrates a peak that exceeds a permissible value for the return loss.

In contrast thereto, for the case that the lay length s is varied in the case of the stranded conductor 4a or rather in the case of the twisted element, the peak in the case of the critical frequency f₀ is considerably reduced and distributed over a wide frequency band. This situation is illustrated qualitatively in FIG. 9B.

By virtue of this feature of the varying lay length s, the signal cable 4a, 4b is suitable in particular for high frequency data transmissions in particular also in the gigahertz range and preferably up to approximately 100 gigahertz.

The following is a summary list of reference numerals and the corresponding structure used in the above description of the invention:

| 2a | Coaxial cable | S | Lay length |
|---|---|---|---|
| 2b | Balanced signal cable | Sₘₐₓ | Maximal lay length |
| 4a | Stranded conductor | Sₘᵢₙ | Minimal lay length |
| 4b | Insulated signal conductor | ΔS | Difference value |
| 6 | Dielectric medium | f₀ | Frequency |
| 8 | Shield layer | d | Diameter |
| 9 | Cable sheath | D | Original signal |
| 10 | Individual wires | D′ | Inverted signal |
| 12 | Longitudinal direction | E | Envelope |
| 14 | Conductor core | L_{1, 2} | Length of envelope |
| 16 | Insulation | L_{ges} | Total length |
| 18 | Parallel wire | | |
| 20 | Feeder device | | |
| 22 | Evaluating device | | |
| 24 | Braided strand | | |

1. A high frequency signal cable for transmitting signals at a frequency in a GHz range, comprising:
insulated signal conductors mutually twisted in pairs being a twisted wire pair, said insulated signal conductors being mutually twisted with a varying lay length for reducing return losses; and
a shielding surrounding said twisted wire pair.

2. The signal cable according to claim 1, wherein said lay length varies about a mean lay length by a difference value.

3. The signal cable according to claim 1, wherein said lay length varies in a non-uniform manner.

4. The signal cable according to claim 2, wherein said mean lay length is in a range of 3 to 50 times a diameter of an insulated signal conductor of said insulated signal conductors.

5. The signal cable according to claim 1, wherein a variation of said lay length is characterized by an envelope that has a length in a range of a few meters.

6. The signal cable according to claim 5, wherein the length of the envelope varies.

7. The signal cable according to claim 5, wherein a value of a maximal lay length or a minimal lay length varies in a case of successive envelopes.

8. The signal cable according to claim 5, wherein a gradient of the envelope varies in a case of successive envelopes.

9. The signal cable according to claim 1, wherein said insulated signal conductors having stranded wires extending in parallel with one another with a respective identical lay length.

10. The signal cable according to claim 1, wherein said insulated signal conductors has only one layer of stranded wires.

11. The signal cable according to claim 1, wherein said lay length is in a range of up to 30 meters.

12. The signal cable according to claim 1, further comprising:
a feeder device connected to said insulated signal conductors, said feeder device embodied such that an original signal that is to be transmitted is fed into a first of said insulated signal conductors and an inverted signal that is inverted with respect to the original signal is fed into a second of said insulated signal conductors; and
an evaluating device connected to said insulated signal conductors, said evaluating device embodied for evaluating a level difference between the original signal and the inverted signal.

13. The signal cable according to claim 1, wherein said shielding is embodied as a braid having individual braided strands that are mutually twisted with a varying lay length.

14. The signal cable according to claim 1, wherein the high frequency signal cable is a balanced signal cable.

15. The signal cable according to claim 1, wherein said mean lay length is in a range of 1 to 40 mm.

16. The signal cable according to claim 1, wherein said lay length is in a range of up to 15 m.

17. A high frequency signal cable for transmitting signals at a frequency in a GHz-range, comprising:
insulated signal conductors being mutually twisted as a star quad to form one twisted element, said insulated signal conductors being mutually twisted with a varying lay length for reducing return losses.

18. A high frequency signal coaxial cable for transmitting signals at a frequency in a GHz range, comprising:
a signal conductor embodied as an inner conductor, said signal conductor being a stranded conductor having a plurality of individual stranded wires and said individual stranded wires being mutually twisted with a varying lay length for reducing return losses.

19. A high frequency balanced signal cable for transmitting signals at a frequency in a GHz range, comprising:
insulated signal conductors being mutually twisted in pairs or as a star quad to form a twisted element, said insulated signal conductors being stranded conductors containing a plurality of individual stranded wires and said stranded wires being mutually twisted with a varying lay length for reducing a return losses.

20. A method of using a signal cable for high frequency signal transmission in a range above 100 MHz, which comprises the steps of:
performing at least one of:
providing a stranded conductor having a plurality of individual stranded wires for use as a signal conductor, wherein a lay length of the individual stranded wires being varied for reducing a return loss; or
providing a balanced signal cable having signal conductors being mutually twisted with a varying lay length for reducing return losses.
